(19) United States
(12) Patent Application Publication
(10) Pub. No.: US 2019/0304236 A1
(43) Pub. Date: Oct. 3, 2019

(54) SYSTEM AND METHOD FOR HANDLING RECYCLABLE MATERIALS

(71) Applicants: Chung Wah Chan, Houston, TX (US); Ricardo J. Perez, Houston, TX (US)

(72) Inventors: Chung Wah Chan, Houston, TX (US); Ricardo J. Perez, Houston, TX (US)

(21) Appl. No.: 16/373,021

(22) Filed: Apr. 2, 2019

Related U.S. Application Data
(60) Provisional application No. 62/651,491, filed on Apr. 2, 2018.

(51) Int. Cl. G07F 7/06; B29B 17/00; G06Q 10/00

(52) U.S. Cl. CPC G07F 7/0609; G06Q 10/30; B29B 17/0026

(57) ABSTRACT

Disclosed embodiments of a system for managing waste materials and tracking the portion of received recyclable materials that are recycled and/or monetized. The disclosed system may include smart balers; imaging devices, such as cameras or video cameras; barcode, QR, RFID or other near field scanners; and one or more processors operably connected to these devices. A processor is typically configured to determine what portion of incoming materials may be recyclable and/or what portion of those incoming recyclable materials are recycled and/or monetized. The processor may also be configured to generate and visualize reports relating to the waste management process including generating a single index number of the capture percentage rate.

### RELATED APPLICATIONS

This application claims the benefit of, and priority to U.S. provisional patent application Ser. No. 62/651,491, filed Apr. 2, 2018. The entire disclosure of 62/651,491 is incorporated herein by reference.

### FIELD OF THE INVENTION

Embodiments described herein are employed for control and management of waste materials and waste material management processes. More particularly, embodiments relate to processes for the handling of waste and recyclable materials.

### BACKGROUND AND SUMMARY

Currently, the solid waste industry does not provide transparency, visibility, and/or trackability regarding potential solid waste stream cost savings and/or monetary gains from capturing recyclable materials. Large amounts of potentially recyclable materials are thrown into land-fills. This process costs the operator the fee of disposing of this material and also prevents the operator from collecting a potential revenue stream associated with selling the recyclable material. What is needed is a system for the comprehensive management of potentially recyclable incoming material, outgoing recyclable material, and/or outgoing waste.

Some embodiments include a knowledge based platform that combines smart technology hardware and analytics. Some embodiments provide data relating to waste material and/or recyclables to operators and/or customers to assist in making business decisions through monitoring, measuring, and managing. Preferred embodiments report a single index number, the Capture Percentage Rate (“CPR”) in order to provide enhanced and streamlined visibility into the waste management processes.

Embodiments of the present disclosure provide a system for recycling material comprising a baler within a facility, the baler communicatively connected to a central server and configured to transmit baler data over a network and a first imaging device positioned to view a recyclable material within the facility. The first imaging device is operably connected to a processor that is arranged to determine a characteristic of the recyclable material based on image data received from the first imaging device.

Embodiments of the present disclosure provide a system for determining a capture percentage rate. The system comprising a central server communicatively connected to a baler and an imaging device configured to monitor the quantity of incoming material, the portion of the of the of the incoming material that is recyclable, and the portion of the incoming material that is balable by the baler.

Embodiments of the present disclosure provide a method of promoting recycling comprising, providing a baler within a facility, wherein the baler comprises a scale with a digital signal output and is communicatively coupled to a processor, the processor configured to record the type of material baled, the number of bales produced in a time period, and the weight of each bale. The method further comprises weighing waste material that enters the facility, wherein the waste material comprises recyclable waste material and non-recyclable waste material; separating recyclable waste material from non-recyclable waste material; determining the weight of the recyclable waste material; determining the weight of the non-recyclable waste material; baling the recyclable waste material; and determining the weight of the baled recyclable waste material and comparing the weight of the baled recyclable waste material to the total weight of the waste material that enters the facility to determine the realized capture percentage rate.

Further features of the disclosed design, and the advantages offered thereby, are explained in greater detail hereinafter with reference to specific example embodiments illustrated in the accompanying drawings.

### BRIEF DESCRIPTION OF THE DRAWINGS

FIG. 1 depicts a baler according to an example embodiment.

FIG. 2 depicts a densifier according to an example embodiment.

FIG. 3 depicts a fullness sensor according to an example embodiment.

FIG. 4 shows a flowchart of an example embodiment of the disclosed system in operation.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The present disclosure relates to systems and processes for use with recycling equipment, data recording devices, computer vision techniques, and predictive modeling for the management of waste streams. Components of some disclosed embodiments include, but are not limited to, balers, smart balers, smart baler retrofits, digital scales, smart scales, smart scale retrofits, imaging devices such as, for example, optical cameras, digital cameras, video cameras, or hyperspectral cameras. Other potential components include radio-frequency identification (“RFID”) and other near field readers, labels, chips, and/or printers, as well as barcode readers, labels, and/or printers. Disclosed embodiments may also comprise other hardware components used to facilitate the automated monitoring, recording, and/or tracking of material in a waste stream.

In some disclosed embodiments, image data and other data is transmitted to a processor(s) or central server(s) which may apply computer vision techniques in order to determine characteristics of a material, artificial intelligence techniques and/or predictive models to streamline a waste management process.

Some preferred embodiments provide real-time or near real-time data collected from smart balers, imaging devices, and/or scanners configured to monitor the processing of waste and recyclable material to a processor or server. Some embodiments record and analyze employee, shift, facility, and/or regional information to provide a comprehensive analysis of a waste processing operation.

When applied, disclosed embodiments may reduce the amount of solid waste sent to a landfill or incineration facility by increasing the amount of recyclable material which is monetized. The disclosed systems aim to increase percentage of all potentially recyclable material that gets recycled and, ideally, monetized. The percent of all potentially recyclable materials received at a facility or by an organization that are actually recycled may be referred to as the Capture Percentage Rate (“CPR”).

As a non-limiting example, a retail store may receive the goods it sells packaged in card board boxes. Additionally, some goods may be packaged using polystyrene, polyethylene, polypropylene, wood pulp, paper products, cloth, foam, film, bottles, glass, metal or other recyclable materials. The disclosed system helps the retail operator account for the total quantity of recyclable material that enters the store. It will be appreciated that the retailer's goods may not be considered recyclable material. The system may then monitor the outgoing streams of waste materials and recyclable materials. Using this information, the disclosed systems are able to determine what percent of the total amount of recyclable materials that enter the store are actually being recycled and what amount are being discarded as waste. This information may be presented as a single number, the CPR.

The exemplary system provides multiple benefits to the retail operator. By presenting a retail store's CPR, the operator is able to judge how effectively it is monetizing its recyclable materials. By increasing the CPR, the operator may be able to increase revenue generated from monetizing recyclable materials and also reduce the expense associated with disposing of non-recyclable waste materials. It will be appreciated that the disclosed systems may be deployed at the individual store or facility level and may also combine information associated with multiple facilities to report a regional and/or enterprise wide CPR. It will also be appreciated that in addition to the single CPR indicator, a significant amount of underlying data and/or other key performance indicators (“KPIs”) may be recorded, reported, visualized, presented, analyzed, and/or used by the operator for a variety of purposes.

Smart Balers such as those disclosed in U.S. Patent Publication 2018/0056618, incorporated herein by reference, allow automatic data gathering from baling devices and/or scales via integrated processors and sensors. These devices help ensure that collected data can be used to increase material handling efficiency. This is done by reducing or eliminating the need to weigh bales via a separate floor scale, as well as eliminating human recording errors, wrong material reporting, and false data. Smart Balers may also add transparency to the measurements of traditional baler productivity, identifying which employee baled which materials, knowing when a material was baled, knowing at what location a material was baled, etc. Smart balers may include, without limitation, horizontal and vertical balers.

Traditional baling devices commonly include a large hollow space enclosed by a safety gate and a door. Material may be loaded into the empty space and compressed, frequently by the action of a piston. Some balers utilize a safety mechanism which requires the door to be locked using a door lock wheel or other mechanism prior to compressing the material in to a bale. Balers commonly have floor gaps which facilitate the insertion of baling wire under the compressed material so that the bale can be tied and completed. Balers are commonly controlled by a standard control panel which contains piston controls, a power indicator, a power disconnect, and/or a panel door lock. Smart balers may also or alternatively contain a separate or integrated smart control panel. The smart control panel may house a processor which may be operably connected to a scale, display screen, imaging device such as a camera, other sensors, and/or baler controls. Balers may be anchored in place using mounting bolts which may be arranged to orient the baler in a fixed level position. Some smart balers will provide a minimum weight indicator and a maximum weight indicator. Smart balers may also contain a separate or integrated weight display which provides the operator with the current weight of the material being baled.

Smart balers address a wide array of concerns by incorporating sensors, imaging devices, processors, and balers in order to increase the amount and reliability of data collected. The sensors detect the weight of a finished bale and, in some embodiments, the data is pushed to a cloud database. Additionally, a local processor and/or database may capture or record weight data as well as images of the product baled and the finished bale. The local processor may be attached to an input device which allows the operator to input data that may not be readily detectable by certain embodiments. The input device will commonly be a keyboard or touch pad, but a mouse, track pad, magnetic card reader, barcode scanner, RFID reader, QR reader or other input device may also be used.

Smart balers may also comprise a printer. The printer will commonly be a label printer. The label printer may print up to all known data regarding a bale and may also encapsulate this data in the form of a tracking device such as a barcode, QR Code or RFID label with an RFID chip. An operator can attach the printed label to the finished bale, thereby ensuring that an accurate record of the bale information accompanies the bale through each step of the recycling chain. In preferred embodiments, the label printer will print onto adhesive stickers so that the labels may be quickly adhered to the bales or bale wrapper without the need for an additional attachment mechanism.

The addition of a tracking device such as a barcode allows for fast and accurate inventory when bales are moved from trucks or other transition points in the recycling chain or possibly moved between storage areas. Certain smart balers use an RFID or other near-field labeling technology to label each bale with some or all of the collected data relating to the bale. This can greatly facilitate accurate inventory control. If RFID chips are used to label each bale, a truck or storage location equipped with an RFID reader can tally each bale moved into and out of the truck or storage location with minimal human involvement.

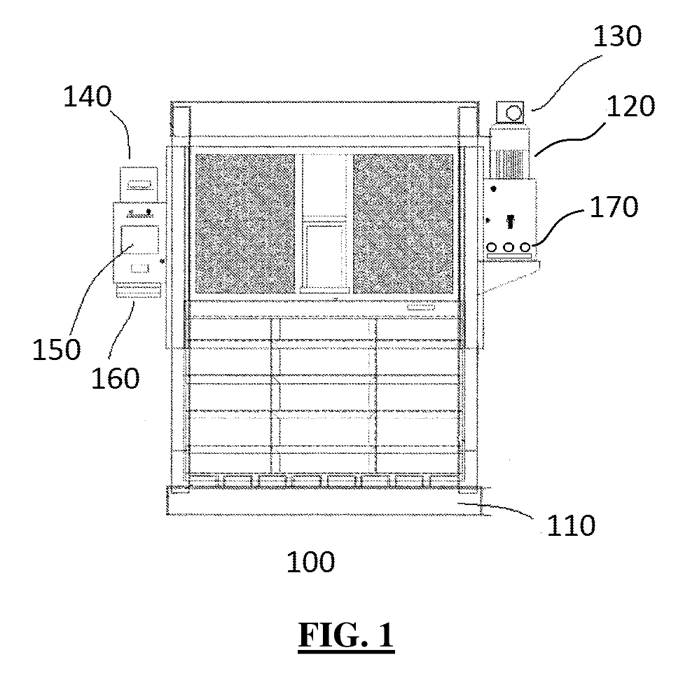

FIG. 1 illustrates a smart baler 100 according to an example embodiment. In this example embodiment, baler 100 is a smart baler with an integrated scale 110 with a digital signal output. The scale 110 is operatively connected to a processor 120. The scale 110 may be configured to weigh the material dynamically as it is being compressed for baling and/or to weigh a completed bale. When measuring the weight of a bale dynamically, the sensed weight changes as operations, such as compressing the material, are performed by the baler. The processor 120 is configured to analyze the dynamic signal from the scale 110 to determine when the bale is complete and/or when a bale should be or has been ejected by the baler. The processor may determine when a bale has exceeded a minimum weight threshold after being compressed and indicate that the bale should be completed. In some embodiments, the baler 100 is arranged to automatically complete the bale upon receiving a signal from the processor. It will be appreciated that the process of completing a bale typically involves wrapping the compressed material with wire, twine, or plastic wrap. In some embodiments, the baler 100 will automatically eject the bale once it has been completed. The dynamic weight measurement may be used to confirm that the bale has been properly ejected from the baler prior to beginning to form the next bale. Using a dynamic weight analysis provides a check on any potential human operator and reduces the possibility of a human operator creating inaccurate data whether intentionally or unintentionally.

In this exemplary embodiments, baler 100 also includes an integrated imaging device 130, such as a camera. The camera 130 may be operably connected to a processor, such as processor 120. The camera 130 may be positioned to view material as it is loaded into the baler 100 and/or the completed bale as it is ejected from the baler. In some embodiments, the processor 120 may be connected to a network and configured to transmit and/or receive data over the network. In some embodiments, the processor 120 may be configured to perform computer vision analysis on image data received from the imaging device 130. In some embodiments, the processor 120 may be in communication with a computer vision processor, a database, and/or a server over the network. In some embodiments, the processor 120 or a computer vision processor in communication with processor 120 is arranged to determine a characteristic of the recyclable material based on image data received from imaging device 130. In some embodiments, the processor 120 may transmit baler data over the network. Baler data may include the weight of a bale, the volume of a bale, the type of material baled, the number of bales produced in a time period, the time material is initially loaded into the baler for a particular bale, the time a bale is completed, the time a bale is ejected, the location of the baler, and/or the identity of a human operator.

In the exemplary embodiment of FIG. 1, baler 100 includes a printer 140 for printing labels containing information related to a bale. Baler 100 may also include a control panel 150, an input device 160, and indicators 170.

In many embodiments, a smart baler is originally designed and manufactured to incorporate the described smart technologies. In some embodiments, a traditional baler may be retrofit with various monitors, scales, sensors, and other smart technologies in order to convert an existing baler into a smart baler. It will be understood that references to a smart baler may include smart balers which are originally designed and manufactured as such as well as traditional balers which have been retrofit with smart technologies such as, for example, those described in U.S. Patent Publication 2018/0056618, incorporated herein by reference.

As one of many possible examples, an alternative embodiment of the disclosed invention is a retro-fit of an existing traditional baler such as, for example, a Mil-Tek baler, compactor or crusher or any other existing baling device. A scale or other weighing device may be incorporated into an existing traditional baler. This scale can be operably connected to a processor which can automatically record the weight of the bale as well as the other data discussed throughout. Imaging devices such as a camera can also be operably connected to the processor. The camera can be configured to take pictures of the finished bale as well as the material being loaded into the baler in order to confirm that operator accurately identified the material being baled. In some embodiments, computer vision techniques may be used in order to determine the start time and completion time of each bale, the composition of each bale, and/or the other data discussed herein. The processor can be operably connected to a printer, such as a label printer, which prints labels displaying all of the necessary information for efficient tracking and management of each bale as well as efficient management of baling operations at the operator, location, region and/or enterprise level. The processor may be connected to a database, cloud or otherwise, and record all of the collected data in the database for further analysis as discussed throughout. The end result of a retro-fit traditional baler may be similar or identical in capabilities to a smart baler depending on the specific equipment incorporated and the arrangement of that equipment. It will be apparent that various distinct situations may require more or less incorporated equipment depending on the specific conditions in which the smart baler is deployed.

In some embodiments, a smart, digital, and/or connected scale may be utilized without necessarily being incorporated into a baler as discussed above. In such embodiments, smart technologies may be utilized to generate and/or gather data regarding at least one of the multiple material characteristics discussed herein, but the baler, compactor, and/or compressor, if such devices are utilized, may be traditional devices without integrated smart technologies. Many such embodiments will require a human operator to transfer material from a storage location or from a baler to the smart scale in order to generate weight and/or other data. Alternatively or additionally, a conveyor system, hoist system, or other automated transport system may be utilized to transfer material from an initial location to a smart scale in order to generate and collect the desired data.

Exemplary embodiments may include one or more networks. In some examples, the network may be one or more of a wireless network, a wired network or any combination of wireless network and wired network, and may be configured to connect a card reader and/or mobile device to a server. For example, the network may include one or more of a fiber optics network, a passive optical network, a cable network, an Internet network, a satellite network, a wireless LAN, a Global System for Mobile Communication (GSM), a Personal Communication Service (PCS), a Personal Area Network, Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g, Bluetooth, Near Field Communication (NFC), Radio Frequency Identification (RFID), Wi-Fi, and/or the like.

In addition, the network may include, without limitation, telephone lines, fiber optics, IEEE Ethernet 902.3, a wide area network (WAN), a wireless personal area network, a local area network (LAN), or a global network such as the Internet. In addition, the network may support an Internet network, a wireless communication network, a cellular network, or the like, or any combination thereof. The network may further include one network, or any number of the exemplary types of networks mentioned above, operating as a stand-alone network or in cooperation with each other. The network may utilize one or more protocols of one or more network elements to which they are communicatively coupled. The network may translate to or from other protocols to one or more protocols of network devices. Although the network is referred to as a single network, it should be appreciated that according to one or more embodiments, the network may comprise a plurality of interconnected networks, such as, for example, the Internet, a service provider's network, a cable television network, corporate networks, such as credit card association networks, and home networks.

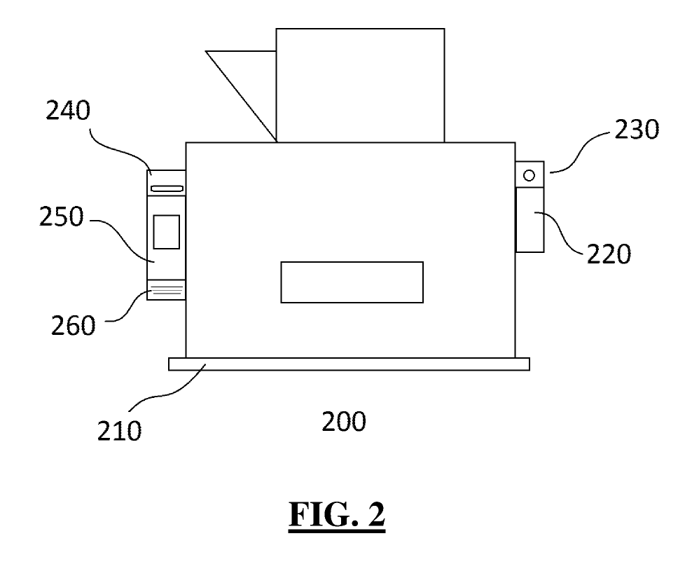

FIG. 2 illustrates a densifier 200 according to an example embodiment. In this example embodiment, densifier 200 is equipped with an integrated scale 210 with a digital signal output. The scale 210 is operatively connected to a processor 220. The scale 210 may be configured to weigh the material dynamically as it is being densified and/or may be configured to weigh finished densified blocks. Densifiers are commonly used to process recyclable foams and/or polymers through a process of shredding and heating. Densifier 200 may be configured to extrude a densified block of recycled material. Densifiers are commonly used to reduce the size of three main types of foam: polystyrene, polyethylene, and polypropylene, but may be used to condense and/or densify many other materials as is known in the art.

In the exemplary embodiments, densifier 200 also includes an integrated imaging device 230, such as a camera. The camera 230 may be operably connected to a processor, such as processor 220. The camera 230 may be positioned to view material as it is loaded into the densifier 200 and/or the densified block as it is ejected from the densifier. In some embodiments, the processor 220 may be connected to a network and configured to transmit and/or receive data over the network. In some embodiments, the processor 220 may be configured to perform computer vision analysis on image data received from the imaging device 230. In some embodiments, the processor 220 may be in communication with a computer vision processor, a database, and/or a server over the network. In some embodiments, the processor 220 or a computer vision processor in communication with processor 220 is arranged to determine a characteristic of the recyclable material being densified based on image data received from imaging device 230. In some embodiments, the processor 220 may transmit densifier data over the network. Densifier data may include the weight of a block, the volume of a block, the type of material densified, the number of blocks produced in a time period, the time material is initially loaded into the densifier for a particular block, the time a block is ejected, the location of the densifier, and/or the identity of a human operator.

In the exemplary embodiment of FIG. 2, densifier 200 includes a printer 240 for printing labels containing information related to a densified block. Densifier 200 may also include a control panel 250, and an input device 260.

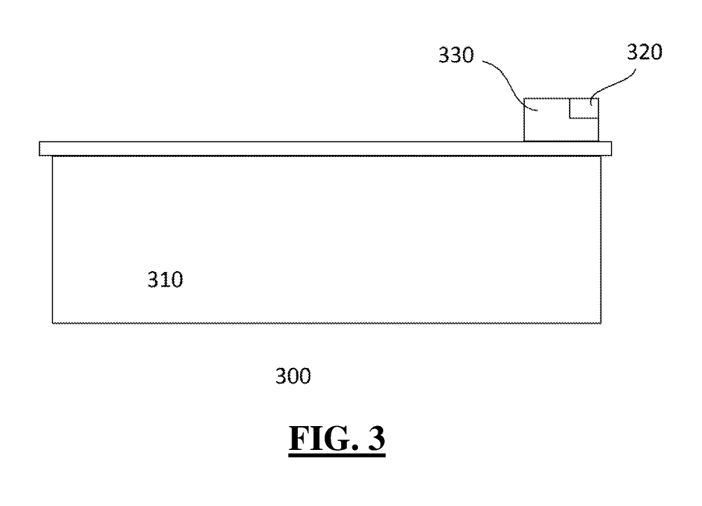

FIG. 3 illustrates a container with fullness sensor 300 according to an example embodiment. The container may be any container suitable for containing waste materials, such as recyclable materials. In this example embodiment, fullness sensor 300 is operatively connected to a processor 320 and configured to monitor the amount of material within the container 310. Fullness sensor 300 may monitor the absolute amount of material in container 310 or may monitor the relative fullness of the contain 310. In some embodiments fullness sensor 300 may be an image based sensor or an ultra-sonic sensor. In the exemplary embodiments, fullness sensor 300 includes an imaging device 330. The imaging device 330 may be operably connected to a processor, such as processor 320. The imaging device 330 may be positioned to view material within the container 310. In some embodiments, the processor 320 may be connected to a network and configured to transmit and/or receive data over the network. In some embodiments, the processor 320 may be configured to perform computer vision analysis on image data received from the imaging device 330. In some embodiments, the processor 320 may be in communication with a computer vision processor, a database, and/or a server over the network. In some embodiments, the processor 320 or a computer vision processor in communication with processor 320 is arranged to determine a characteristic of the recyclable material within the container 310 based on image data received from imaging device 330. In some embodiments, the processor 320 may transmit data relating to the fullness of container 310 over the network. This data may be useful in scheduling recycling operations, pick-up and/or removal of the material within the container 310.

Embodiments of the disclosed system are arranged to provide increased visibility into a waste handling process. By centralizing much or all of this data in a database(s), such as, for example, a remote or cloud database, a coordinated and detailed analysis of all waste and/or recyclable materials for a given location and/or enterprise may be created and maintained with relatively little human input. Collected data may also be accessible at any time and/or from any location by allowing a user to log into the database remotely. The described approach to managing recyclable materials allows for the identification of inefficiencies at both individual baling stations as well as enterprise wide operations. In some embodiments of the disclosed system, this data is initially collected using disclosed embodiments of a baler with integrated or associated sensors such as a smart baler.

Some embodiments of the disclosed systems include an imaging device, such as a scanner, camera, video camera, and/or hyperspectral camera operably connected to a processor. An imaging device may be positioned to view material, for example, as it is entering a facility, while it is stored, when it is fed into a baler or densifier, as the material is being baled, as the baled or densified material is exiting a baler or densifier, as the bale or block of material is stored, and/or as the bale and/or block of material is loaded onto a truck or otherwise removed from a facility.

In some embodiments, a processor may be configured to receive image data from an imaging device to determine a characteristic of the waste material and/or recyclable material. This characteristic may be the composition and/or type of the recyclable material, the volume of the material, the weight of the material, the components of the material, and/or whether the material is recyclable. This information may be used to label a bale or block which is formed from the recyclable material or to confirm a manual entry input by an operator is accurate.

In some embodiments, a processor may be configured to monitor the total quantity of a given material(s) that has been baled, densified, or otherwise processed in a given time period. This information may be used, along with information related to the total amount of material received at a particular location to determine the overall portion of recyclable material that has been captured for baling or recycling.

Some disclosed embodiments use imaging devices to monitor and/or quantize the waste materials, including recyclable materials that enter a facility over a given time and how those materials are processed prior to being transported away from a facility. The visual data and/or image data captured by the imaging devices may be analyzed using a processor. The processor may be integral to the imaging device or remote. The automated and/or processor-based interpretation of image data may be known as computer vision. In some embodiments, the disclosed processor is or is operably connected to a computer vision processor. It will be appreciated that the processor may be configured to execute computer vision applications, programs, software, and/or techniques which may be stored on local and/or remote servers and/or memory.

The process of detection characteristics of the materials may include one or a plurality of computer vision and/or feature detection algorithms including, but not limited to a histogram of oriented gradients (HOG), integral channel features (ICF), aggregated channel features (ACF), and/or deformable part models (DPM). In some embodiments, tracking algorithms may also be utilized including, but not limited to Kalman filters, particle filters, and/or Markov chain Monte Carlo (MCMC) tracking approaches. Different algorithms may provide unique performance characteristics in terms of accurately determining material characteristics. Each computer vision and/or feature detection approach may also provide differing performance characteristics based on the lighting and/or other visual characteristics of a particular deployment.

Some embodiments of the disclosed systems incorporate multiple technologies into a unified process for receiving, tracking, and/or identifying material as it enters a facility. The process may also involve separating recyclable materials from non-recyclable materials, baling the recyclable material, baling the non-recyclable material, and/or otherwise preparing the materials to be removed from the facility. Potential methods of preparing material for removal include, but are not limited to compressing, dissolving, melting, shrinking, densifying, wrapping, boxing, caging, and/or palletizing material. Data may be generated and/or collected during each step in this process either manually or automatically. As discussed, imaging devices and computer vision techniques may be used to identify and/or quantify incoming material. Scales which are operably connected to a processor may be used to determine and automatically record the amount of material received. A processor or server in communication with a database may determine what portion of incoming material is recyclable. This information may also be collected using RFID or other near field communication labels or may be manually determined and entered into a terminal and/or database by an operator.

Data may be generated and/or collected as the recyclable and/or non-recyclable material is being baled or otherwise prepared for removal. Such data may include, but is not limited to, bale identification numbers which may correspond with the type of material, weight of material, volume of material, date and/or time the material was baled, identification of what shipment and/or package the material was part of when the material was initially received, the origin of the material, and/or information relating to the pricing or other financial aspects of the material. Any and/or all of this data may be communicated between a processor located at the facility and a remote server or database which stores, collects, and/or analyzes such information. Databases, processors, and servers used for collecting, generating, storing, and/or analyzing data may be located at the facility but will more commonly be located remotely.

The disclosed system may monitor the rate at which material is being prepared for removal and the quantity of baled or prepared material already being stored. Using this information, along with known information such as how much material may be removed during a single pick-up, the system may generate an expected pick-up time for the material. This process may utilize information including but not limited to the current amount of material collected, the available storage space for materials, the cost of pick-up and/or delivery to one or multiple locations, the anticipated price of the material at one or multiple locations, the time required to load material for pick up, the scheduling of operations at the facility, the anticipated lead time between sending a pick-up request and the pick-up occurring, and/or a wide variety of financial information relating to the material.

It will be appreciated that the disclosed system has generally been described with respect to a single facility, but many embodiments of the disclosed system will related to multiple facilities which may be governed as an enterprise. In such embodiments, data may be collected and/or generated which compares multiple facilities relative to each other in order to determine best practices and/or increase the desired performance of each facility and/or the enterprise as a whole. It will also be appreciated that in such embodiments, the various facilities may serve different purposes from one another. This creates the possibility of, for example, transporting material from one facility to another with additional storage space prior to scheduling a pick-up of the material to be monetized or otherwise removed. This may allow for larger single shipments of material which may allow for greater economies of scale including delivering material to more remote locations which may have a more desirable price for a given material.

Embodiments of the disclosed system may comprise a database in which information relating to incoming material is entered, either manually or automatically. In certain embodiments, a human operator may input the quantity and type of materials that are entering a facility into the database. In other embodiments, this information may be automatically determined using computer vision techniques and an imaging device, such as a camera, positioned to view incoming material as it enters the facility. This information may be used to determine the total amount of recyclable materials that have entered a facility in order to determine the CPR of the facility. In some embodiments, an imaging device may be positioned to view material as it is entering the facility. A processor may be operably connected to the imaging device and configured to receive image data. The processor may use computer vision techniques to automatically determine characteristics of the incoming material such as the type of material, volume of material, weight of material, components of the material, and/or the portion of the incoming material which is recyclable.

The disclosed processor and/or database may be provided with information regarding the specific facility in which the disclosed system is operating. If a particular facility has a specified amount of storage space, the processor may be configured to determine the rate at which baled and/or recyclable material is accumulating and determine approximately when the storage space will be full. Based on these calculations, the processor may be configured to schedule a pick-up at the appropriate time. This feature may be utilized in order to avoid storing excessive amounts of material and also to avoid paying excessing costs associated with picking up materials.

Preferred embodiments of the disclosed system generate a single index capture percentage rate using the above described technologies including, but not limited to scales, weight sensors, cameras, video cameras, bar code, QR scanners, RFID scanners, and/or near field communication readers which may be operably connected to a processor. The processor gathers this information in order to determine what portion of recyclable material that is entering a given facility is being recycled and/or monetized. This allows an operator to quickly determine the overall efficiency of its waste management processes. This data may be reported to an operator in real-time or as a longer term report covering a pre-determined time frame such as hourly, daily, weekly, monthly, and/or annually.

In some preferred embodiments, an audit database is utilized in order to check, determine, and/or confirm the quality of the collected, gathered, and/or generated data. Data collected in the audit database may be utilized in order to check the validity of the raw data collected including any raw data which is manually entered by a human operator or is dependent on data generated by a human operator. In certain embodiments, only automatically generated data may be collected in a particular database. That automatically collected data may then be analyzed in order to reverse engineer expected values for information which may has been entered by a human operator or is dependent on information entered by a human operator. This type of data audit may be used in order to determine the accuracy of the human data entered. These datasets may be visualized or otherwise compared in order to clarify any potential sources of inaccurate data and/or to generate a confidence indicator regarding the generated and/or collected data. In general, it is preferable to collect and/or generate as much information as possible automatically and without the input of a human operator. This provides a check on data entered by a human operators as discussed and helps to avoid potential time delays and human error.

One potential exemplary embodiment of the disclosed data audit system involves checking for operator error as follows: Operator 1 enters his personal identification into a smart baler that he will be operating and enters an identifier for Material 1, the type of material that he will be handling. Operator 1 proceeds to work a shift. After Operator 1 has completed his shift, Operator 2 proceeds to use the same baler and handles Material 1 for the first half of his shift and Material 2 for the second half of his shift. Due to human error, Operator 2 may forget to input his own personal identification, and thereby fail to inform the baler and associated databases when he is working as opposed to Operator 1. In this instance, there will be an inaccurate record that shows Operator 1 working two consecutive shifts and Operator 2 not working at all rather than showing Operator 1 working a single shift and Operator 2 working the next shift.

Similarly, Operator 2 may forget to enter a new material identification when he stops baling Material 1 and starts to bale Material 2. In this instance, there will be a false record which over-reports the amount of Material 1 baled and under-reports the amount of Material 2 baled. It will be appreciated that these are merely examples and that there are numerous other opportunities for human operator error to create an inaccurate record.

In some embodiments, an auditing system may be used to cross-check shifts worked by each operator against an planned work schedule. In this case, the auditing system may identify the inconsistency between the planned working schedule and the reported working schedule. Once an inconsistency between multiple sources of data has been identified, the originally entered data may be maintained as raw data and an updated corresponding record showing the expected data may be generated as auditing data. In some embodiments, the system may present this data to a manager or other personnel for further investigation.

In some embodiments of the disclosed systems an imaging device is operably connected to a processor. In these embodiments, the processor may be configured to determine the identity of an operator based on facial recognition or computer vision techniques. The processor may also or alternatively be configured to identify the material being processed using computer vision techniques and the visual data transferred form the imaging device to the processor. In this exemplary embodiment, there will be a record, generated by the imaging device and processor, of how many bales of each material were baled at a given time and place. In the instance in which Operator 2 stops baling Material 1 and begins to bale Material 2, but fails to enter the new identification code for Material 2, there will be conflicting reports regarding how much of Materials 1 and 2 were baled during that shift. In this situation, similar to the situation described above, the audit system may cross reference the various reports and identify the conflicting information. The underlying information may be maintained, but the auditing system may visualize or otherwise highlight the conflicting data for further investigation. In some embodiments, the system may be configured to generate a new record which gives preference to automatically generated information which is less susceptible to human error. In certain embodiments, there may be multiple sources of information which confirm the fact that Operator 2 forgot to identify that he had stopped baling Material 1 and started to bale Material 2. In such instances, the system may generate an updated report. In some embodiments, this update report will highlight the underlying conflict of information. In certain embodiments, the system will only present the revised or updated information determined to be the most accurate. The system may be configured to present conflicting information based on a pre-determined confidence threshold or based on the ratio of data sources that agree relative to the number of conflicting data sources. Known computer tally techniques or other methods for determining the confidence associated with a data set may be utilized when a conflict in data is detected.

Disclosed embodiments will utilize at least one of many potential performance indicators. Capture Percentage Rate (CPR) is typically equal to R/(W+R) where R is the weight of total recyclables and W is the weight of total waste (where waste could be landfilled waste or incinerated waste). Metrics other than weight may be utilized in order to compare the ratio of recyclable materials to the total of recyclables plus waste materials. Other such metrics include, but are not limited to, volume, bales, containers full, and/or truckloads and the like.

Another potential KPI may be Income Opportunity. This is a measurement of revenue plus cost savings that a facility may realize. This, and other KPIs may be calculated for individual facilities, or by region, or enterprise.

In a non-limiting example of income opportunity, Company A has a maximum possible CPR of 98% (meaning 2% of the total incoming material is non-recyclable and the remaining 98% could be monetized), but is only realizing a CPR of 50%. In this exemplary circumstance, there is a dollar amount related to the potential increase in CPR related to increased revenue generation from monetizing recyclables. Since the finite total amount of material is defined as non-recyclable waste “W”+recyclable material “R”, as R increases, W decreases. Organizations typically must pay to have non-recyclable waste removed, therefore W is typically associated with a cost. When the W amount decreases, there will be a dollar amount related to this W reduction which may be interpreted as savings. This may be equally interpreted as income in the form of expense reduction. In some cases, there may be additional savings from reduced sizing of waste equipment and/or labor savings. In addition to the savings from reducing W, there may be an increase in direct revenue associated with the increasing R value. By capturing and monetizing a greater portion of recyclable materials, a company may see a direct increase in revenue in addition to reduced costs. The total amount of unrealized savings and revenue is referred to as the income opportunity. There are numerous potential components which make up the total income opportunity. In some embodiments, these components and/or the complete income opportunity associated with increasing a company's CPR may be reported, visualized, considered, and/or utilized as performance metrics either individually or in combination with other metrics.

In this example, as more data is collected or otherwise becomes available and as more actions utilizing that data are implemented, CPR will gradually increase from the initial 50% towards the theorized maximum of 98%. As a company or facility approaches the maximum potential CPR, the income opportunity will decrease.

Additional performance indicators which may be utilized include, but are not limited to, Total Recyclable Revenue, Total Recyclable Weight, Total Waste Weight, and Total Environmental Impact which may include the number of cubic yards of landfill space saved, the amount of carbon dioxide reduced, the number of trees saved, the number of barrels of oil saved, the number of homes powered, and/or the BTUs of energy saved.

In addition to imaging devices, balers, and scales, several other sources of information may be utilized in order to collect information. Data may be gathered automatically or entered manually by a human operator. This data includes, but is not limited to, the weight or volume of waste landfilled or incinerated; the weight or volume of recyclables as captured by balers, densifiers, and/or containers; the number of wooden pallets, plastic pallets, and/or other containers utilized or collected; revenue related to monetized recyclables; savings related to waste reduction; cost savings related to reduced labor and/or the reduced frequency of waste disposal pickups and/or drop-offs.

The disclosed system, methods, equipment, and processes allow the user to visualize, simulate, and/or take action to make improvements in the waste management process. Disclosed systems may also allow for identification of opportunities which have not yet been realized and the necessary actions to be taken in order to realize any opportunities found.

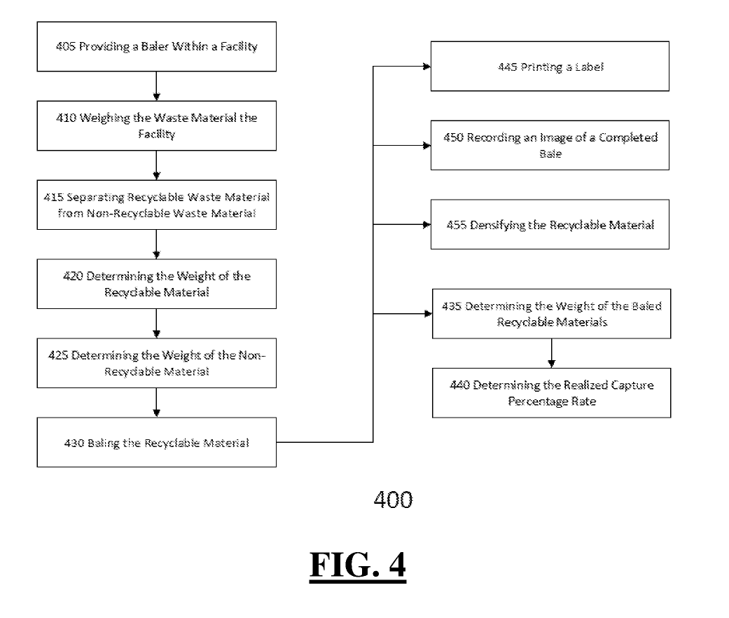

FIG. 4 shows method 400 of recycling waste materials using according to an exemplary embodiment. Method 400 includes, at step 405, providing a baler within a facility. The baler comprises a scale with a digital signal output and is communicatively coupled to a processor. In this exemplary embodiments, the processor is configured to record the type of material baled, the number of bales produced in a time period, and the weight of each bale. Step 410 includes weighing or otherwise quantizing the amount of waste material that enters a facility. It will be appreciated that the waste material entering the facility may include recyclable materials and/or non-recyclable materials. Once the total amount of waste materials entering the facility has been weighed or quantized, at step 415, the recyclable materials are separated from the non-recyclable materials. The recyclable and non-recyclable materials may be stored in separate containers be processed immediately after being separated. Step 420 includes determining the weight of the recyclable material. Step 425 includes determining the weight of the non-recyclable materials. It will be appreciated that the weight of the recyclables, non-recyclables, or total waste materials may be determined without direct measurement if the other two quantities are known. At step 430, the recyclable materials are baled using a baler. In some embodiments, the recyclable materials or a portion of the recyclable materials may be densified, wrapped, or otherwise processed in addition to or instead of baling the materials. At step 435, the weight of the baled or otherwise processed recyclable waste material is determined. It will be appreciated that not all of the recyclable materials that enter a facility may be separated from the non-recyclable materials and/or processed. In most circumstances, at least some recyclable material will not be processed or later monetized. Step 440 includes comparing the weight of the baled or otherwise processed recyclable materials to the total weight of the recyclable waste material that entered the facility. This comparison is used to determine the realized capture percentage rate or the percent of the total recyclable material that enters a facility that is processed. In most embodiments, recyclable materials may be monetized after they have been processed.

In some embodiments, exemplary method 400 optionally includes, at step 445, printing a label comprising bale information; at step 450, recording an image of a completed bale using an imaging device; and/or at step 455 densifying the recyclable material.

Disclosed embodiments relate to a system for recycling material comprising: a baler within a facility, the baler communicatively connected to a central server, wherein the baler is configured to transmit baler data over a network, and wherein the server is configured to receive baler data; and a first imaging device positioned to view a recyclable material within the facility, the first imaging device operably connected to a processor, the processor arranged to determine a characteristic of the recyclable material based on image data received from the first imaging device. In some embodiments, the baler data comprises: weight of a bale, volume of a bale, type of material, or number of bales produced in a time period. Some embodiments, further comprise a second imaging device positioned to view an incoming material, the second imaging device operably connected to a processor, the processor communicatively coupled to a network, wherein the processor is arranged to determine a characteristic of the incoming material based on image data received from the second imaging device. In some embodiments, the characteristic of the incoming material comprises: the type of the incoming material, volume of the incoming material, weight of the incoming material, components of the incoming material, or whether the incoming material is recyclable. In some embodiments, the processor is configured to determine the quantity of the incoming material, the portion of the of the incoming material that is recyclable, and the portion of the incoming material that is balable by the baler, and wherein the processor transmits this data over a network to the central server. In some embodiments, the processor determines a characteristic of the recyclable material using computer vision techniques; the data indicating the quantity of incoming material, the portion of the of the incoming material that is recyclable, and the portion of the incoming recyclable material that is balable is recorded in a database; the central server applies a predictive model to the data recorded in the database and the baler data to determine a schedule for transporting baled material out of the facility; the central server sends a notification to a transporter, the notification comprising scheduling information; the central server is determines a capture percentage rate from the data recorded in the database and the baler data; and/or the image data from the first and second imaging devices, the quantity of the incoming material, the portion of the of the incoming material that is recyclable, the portion of the incoming recyclable material that is balable, and the baler data are displayed in a control center. Some embodiments further comprise a densifier, the densifier communicatively connected to the central server and configured to transmit densifier data over a network; a third imaging device positioned to view a recyclable material as it is loaded into the densifier, the third imaging device operably connected to a processor, the processor configured to determine a characteristic of the recyclable material based on image data received from the third imaging device; and a fullness sensor positioned to monitor the fullness of a container, the fullness sensor communicatively connected to the central server.

Some disclosed embodiments relate to a method of recycling material comprising: providing a baler within a facility, wherein the baler comprises a scale with a digital signal output and is communicatively coupled to a processor, the processor configured to record the type of material baled, the number of bales produced in a time period, and the weight of each bale; weighing waste material that enters the facility, wherein the waste material comprises recyclable waste material and non-recyclable waste material; separating recyclable waste material from non-recyclable waste material; determining the weight of the recyclable waste material; determining the weight of the non-recyclable waste material; baling the recyclable waste material; determining the weight of the baled recyclable waste material; and comparing the weight of the baled recyclable waste material to the weight of the total recyclable waste material that enters the facility to determine the realized capture percentage rate. In some embodiments, the baler is configured to dynamically weight a material as it is loaded into the baler and determine when a bale is complete; the baler prints a label comprising bale information upon determining a bale is complete; the bale information comprises the weight of the bale, volume of the bale, type of material baled, or time the bale was completed; and/or the baler comprises an imaging device and records an images of a completed bale. Some embodiments further comprise the step of densifying the recyclable waste material into a block using a foam densifier within the facility, wherein the foam densifier comprises a scale with a digital signal output and is communicatively coupled to a processor, the processor configured to record the type of material densified, the number of blocks produced in a time period, and the weight of each block.

Throughout the specification, reference is made to balers and smart balers. It will be understood that baler and/or smart baler may include any device which compresses a material into a more compact form. It will also be understood that a baler operatively connected to a digital scale will be considered a smart baler. While a smart baler may include many other sensors, processor, or components, these are not required for a baler to be considered a smart baler.

Throughout the specification, reference is made to a recyclable material or materials. Many materials may be recycled or disposed of other than in a landfill or incinerator. It will be understood that any material which may be monetized after its initial use may be considered a recyclable material.

The present disclosure is not to be limited in terms of the particular embodiments described in this application, which are intended as illustrations of various aspects. Many modifications and variations can be made without departing from its spirit and scope, as may be apparent. Functionally equivalent methods and systems within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents.

In the preceding specification, various preferred embodiments have been described with references to the accompanying drawings. It may, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

What is claimed is:

1. A system for recycling material comprising:
a baler within a facility, the baler communicatively connected to a central server, wherein the baler is configured to transmit baler data over a network, and wherein the server is configured to receive baler data; and
a first imaging device positioned to view a recyclable material within the facility, the first imaging device operably connected to a processor, the processor arranged to determine a characteristic of the recyclable material based on image data received from the first imaging device.

2. The system of claim 1, wherein the baler data comprises: weight of a bale, volume of a bale, type of material, or number of bales produced in a time period.

3. The system of claim 1, further comprising a second imaging device positioned to view an incoming material, the second imaging device operably connected to a processor, the processor communicatively coupled to a network, wherein the processor is arranged to determine a characteristic of the incoming material based on image data received from the second imaging device.

4. The system of claim 3, wherein the characteristic of the incoming material comprises: the type of the incoming material, volume of the incoming material, weight of the incoming material, components of the incoming material, or whether the incoming material is recyclable.

5. The system of claim 3, wherein the processor is configured to determine the quantity of the incoming material, the portion of the of the incoming material that is recyclable, and the portion of the incoming material that is balable by the baler, and wherein the processor transmits this data over a network to the central server.

6. The system of claim 1, wherein the processor determines a characteristic of the recyclable material using computer vision techniques.

7. The system of claim 5, wherein the data indicating the quantity of incoming material, the portion of the of the incoming material that is recyclable, and the portion of the incoming recyclable material that is balable is recorded in a database.

8. The system of claim 7, wherein the central server applies a predictive model to the data recorded in the database and the baler data to determine a schedule for transporting baled material out of the facility.

9. The system of claim 8, wherein the central server sends a notification to a transporter, the notification comprising scheduling information.

10. The system of claim 7, wherein the central server is determines a capture percentage rate from the data recorded in the database and the baler data.

11. The system of claim 5, wherein the image data from the first and second imaging devices, the quantity of the incoming material, the portion of the of the incoming material that is recyclable, the portion of the incoming recyclable material that is balable, and the baler data are displayed in a control center.

12. The system of claim 2, further comprising:
a densifier, the densifier communicatively connected to the central server and configured to transmit densifier data over a network;
a third imaging device positioned to view a recyclable material as it is loaded into the densifier, the third imaging device operably connected to a processor, the processor configured to determine a characteristic of the recyclable material based on image data received from the third imaging device; and
a fullness sensor positioned to monitor the fullness of a container, the fullness sensor communicatively connected to the central server.

13. A method of recycling material comprising:
providing a baler within a facility, wherein the baler comprises a scale with a digital signal output and is communicatively coupled to a processor, the processor configured to record the type of material baled, the number of bales produced in a time period, and the weight of each bale;
weighing waste material that enters the facility, wherein the waste material comprises recyclable waste material and non-recyclable waste material;
separating recyclable waste material from non-recyclable waste material;
determining the weight of the recyclable waste material;
determining the weight of the non-recyclable waste material;
baling the recyclable waste material;
determining the weight of the baled recyclable waste material; and
comparing the weight of the baled recyclable waste material to the weight of the total recyclable waste material that enters the facility to determine the realized capture percentage rate.

14. The method of claim 13, wherein the baler is configured to dynamically weight a material as it is loaded into the baler and determine when a bale is complete.

15. The method of claim 14, wherein the baler prints a label comprising bale information upon determining a bale is complete.

16. The method of claim 15, wherein the bale information comprises the weight of the bale, volume of the bale, type of material baled, or time the bale was completed.

17. The method of claim 14, wherein the baler comprises an imaging device and records an images of a completed bale.

18. The method of claim 13, further comprising the step of densifying the recyclable waste material into a block using a foam densifier within the facility, wherein the foam densifier comprises a scale with a digital signal output and is communicatively coupled to a processor, the processor configured to record the type of material densified, the number of blocks produced in a time period, and the weight of each block.
